(19) United States
(12) Patent Application Publication
(10) Pub. No.: US 2005/0278158 A1
(43) Pub. Date: Dec. 15, 2005

(54) Method for modeling the effect of a stimulus on an environment

(76) Inventors: William T. Ellison, Goshen, CT (US); Jacquin Buchanan, Ijamsville, MD (US); Adam S. Frankel, Shady Side, MD (US)

Correspondence Address: EDWARDS & ANGELL, LLP, P.O. BOX 55874, BOSTON, MA, 02205, US

(21) Appl. No.: 10/977,389

(22) Filed: Oct. 29, 2004

Related U.S. Application Data
(60) Provisional application No. 60/514,913, filed on Oct. 29, 2003.

(51) Int. Cl. G06G 7/48

(52) U.S. Cl. 703/6

(57) ABSTRACT

A creature animat movement, tracking and detection model in combination with a source stimulus propagation model to quantify expected levels of stimulus dosages in a virtual environment as well as the relative effectiveness of detection sensors in the same virtual environment. The method compensates for the inherent variability and uncertainty of input data related to creature animats, their detection and tracking and stimulus propagation. Preferably, the compensation is accomplished by selecting a random value from the input variable distribution and running the model as if it were deterministic. The method may be run wholly random, wholly deterministic or in combination. The method is controlled by a master clock insuring the correct simultaneous coincidence of animat locations, stimuli and detection signals. Repitition of running with random values yields a significant distribution that allows for application of statistical measures to account for the inherent variability and uncertainty.

### CROSS-REFERENCE TO RELATED APPLICATION

This application claims priority to U.S. Provisional Patent Application No. 60/514,913, filed Oct. 29, 2003, which is incorporated herein by reference.

### BACKGROUND OF THE INVENTION

1. Field of the Invention

The subject disclosure relates to methods and systems for modeling and/or predicting the effect of stimuli in virtual environments, and more particularly to improved methods and systems for determining the impact of foreign sound and other forms of pollution upon terrestrial, aquatic and aerial animals (including humans), as well as evaluating the effectiveness of both passive and active detection devices in tracking aquatic wildlife.

2. Background of the Related Art

Conservation and protection of the marine environment is becoming an increasingly important goal for many ocean users. Marine mammals are one of the most visible components of the environment and have engendered tremendous interest and affection from the general public. Furthermore, marine mammals are vulnerable to many different types of interactions with humans such as ship strikes when the marine mammals come to the surface to breathe. Marine mammals also have exceptional hearing, making them susceptible to acoustic disturbance and injury. Of course, like other animals, marine mammals are also susceptible to toxic contamination.

To further cause harm to marine mammals, there is continuing whale fishery, which does not appear to be limited to legally caught species. Historical whaling has reduced the population size of many marine mammal species. While there are some examples of remarkable recovery (e.g., eastern gray whales) others remain at dangerously low population levels (e.g., northern right whales, western gray whales). For these and other reasons, there is continuing concern about the welfare of marine mammals and the effects of their interaction with anthropogenic factors. There is also potential harm from sound and other forms of physical pollution to all aquatic life, including human divers. There is also a corresponding need to accurately predict the ability of sensors, both active and passive, to track moving animals in their respective media; e.g. fish and marine mammals in water using sonar, avian animals in air using radar.

In most stimulus-response relationships, there is a direct, if not linear, relationship between the exposure, or dosage, and the response, or effect. When considering marine mammals, measuring the dosage can be difficult. Measuring difficulties are particularly difficult when considering acoustic stimuli. The propagation of sound in the ocean is very complex, and varies with depth as well as range. Furthermore, different species can have very different dive patterns. FIG. 1 shows stylized sperm whale and dolphin dive patterns to highlight the clear differences between the two species in dive depth, time at depth, and time spent on the surface. Some species rarely dive deeper than 100 meters, while sperm whales and elephant seals regularly dive to depths of 1-3 kilometers. These dive pattern variations result in animals sampling different strata of the water column, and therefore potentially exposed to different sound levels from the same source.

In view of the above, there is a need for a method and system that can model each species behavior as well as the propagation of sound from a source to model expected dosage for exemplary animals as individuals and groups. Preferably, the method and system would receive data related to the stimulus and environment as well as typical behavior patterns for a variety of species distributed in the environment to project animal location and exposure to the stimulus at a plurality of time intervals.

Correspondingly there is a need for a method and system to accurately predict the ability of passive and active systems to track animals or other inanimate or man-made objects in their respective environments where such propagation anamolies are present by utilizing the same techniques and modeling just described. In the case of an active sensor, this tracking ability includes the ability to predict the level of sensor generated energy reflected or scatteerd from the animal or object in the forms of echoes or reverberation. This innate ability has its own inherent value independent of assessing the impact of physical stimuli.

### SUMMARY OF THE INVENTION

The present disclosure is directed to a computer for modeling an impact of a stimulus upon an environment as well as the effectiveness of a given sensor to detect and track animals or objects in their respective environments. The computer includes a memory storing an instruction set and data related to a plurality of time intervals, an environment, a creature animat, a detection sensor, and the stimulus. The ‘creature animat’ term as used hereafter is not restricted to animals but may be generalized to humans as well as any deterministic object located within the environment being modeled. The computer also includes a processor for running the instruction set, the processor being in communication with the memory. The processor is operative to initially distribute the creature animat, detection sensors, and stimuli sources in a virtual environment based upon the data related to the environment, simulate a behavior of the creature animat and a propagation of the stimulus for each time interval and record either a dosage of the stimulus upon the creature animat, or its detection, or its echo characteristics. The simulation event can be conducted over an arbitrary interval of time with each of the prescribed behaviors and simulations being evaluated on the basis of a user-controlled master clock that governs the incremental advancement of all aspects of the simulation.

Another embodiment of the subject disclosure is a computer-readable medium whose contents cause a computer system to perform a method for predicting exposure to stimulus. The computer system has a program and a database with functions for invocation by performing the steps of creating an animat simulator having access to data related to the stimulus and a receiver of the stimulus, creating an environmental simulator having access to data related to a virtual environment that represents an actual environment, and simultaneously running the animat and environmental simulators to predict exposure to the stimulus over a plurality of intervals.

Still another embodiment of the subject disclosure is directed to a system for simulating an environment having creatures and at least one stimulus source. The system has a first means for modeling the environment, a second means for modeling the creatures and at least one stimulus, a third means for presenting data generated by the first and second means to a user and a fourth means for synchronizing the first and second means.

Preferably, the method of the subject disclosure compensates for inherent variability and uncertainty of input data related to creature animats. The compensation is accomplished by selecting a random value from an input variable distribution and running a model as if it were deterministic. Continued repitition of runs with a plurality of random values yields a significant distribution that allows for application of statistical measures to account for the inherent variability and uncertainty. This method does not obviate the ability of the methdo to emulate a wholly deterministic creature animat where all movement parameters are known and applied, e.g. from a documented direct observation, or a planned event.

Still another embodiment of the subject disclosure is directed to a system for simulating an environment having creature animats and at least one detection sensor system. A passive detection sensor would have the ability to detect some emanating feature from the creature animat, such as a sound, and also includes such simple passive techniques as visually sighting. An active detection sensor would utilize some form of propagating energy such as used by sonar or radar, that would reflect off the creature animat. The reflected energy would then be detected by another sensor that is not necessarily co-located with the energy source. The system has a first means for modeling the environment, a second means for modeling the creature animats, a third means of modeling the reflection or scattering strength of the creature animat, a fourth means of determining the level of the scattered energy at a receiver sensor, a fifth means of evaluating the net effectiveness of the detection based on environemtal variables such as noise, a sixth means for presenting data generated by the first through fifth means to a user and a seventh means for synchronizing the first and second means.

Still another embodiment of the present disclosure combines an animal movement and tracking model with a stimulus propagation model to quantify expected levels of stimulus dosages in a virtual environment.

Yet another embodiment of the system allows a second order response of the creature animat to change an ascribed behavior such as a movement parameter as a function of the level of the received stimuli. For example, a stimuli exceeding a specified aversion threshold may cause a creature animat to turn away from the source of the stimuli. Similarly, a positive stimuli may cause the creature animat to turn toward the source of the stimuli.

Another embodiment of the system is to distribute or array creature animats in accordance with user-stated aversion rules, e.g. creature animats engaged in certain behaviors such as feeding may be averted to certain geographical regimes based on known prey distributions such as water depth or thermal profiles.

It is still another object of the disclosure to implement real-time evaluation of the aquatic environment, including, without limitation, the effect of environmental parameters from either databases or measured values on propagation from stimuli sources or detection systems. The system can also display the environmental parameters themselves using graphic contours, including but not limited to topography, temperature, and sound velocity.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings.

FIG. 1 is a diagram showing a typical dive pattern for two marine mammals.

FIG. 2 is a block diagram of a computer for implementing a method for measuring a creature animat's exposure and/or detectability to a source or detection stimulus in a virtual environment in accordance with the subject disclosure. The animat simulator includes a basic tool set for animat, source and receiver properties.

FIG. 3 is somewhat schematic diagram of the functional modules for implementing a method in accordance with the subject disclosure.

FIG. 4 is a flow diagram of a method in accordance with the subject disclosure.

FIG. 5 illustrates a typical cetacean surface-dive cycle.

FIG. 6A is an exemplary output as seen by a user in accordance with the subject disclosure, showing the levels of sound that creature animats were exposed to from a passing sonar system.

FIG. 6B is another exemplary output generated from the computer of FIG. 2 showing the effectiveness of a high-frequency active sonar system to track whales.

FIG. 7 is an exemplary screen generated from the computer of FIG. 2 for building animat movement behavior with user-specified parameters.

FIG. 8 is an exemplary screen generated from the computer of FIG. 2 for building animat acoustic detection behavior with user-specified parameters.

FIG. 9 is an exemplary screen generated from the computer of FIG. 2 for building source stimuli characteristics with user-specified parameters.

FIG. 10 is an exemplary screen generated from the computer of FIG. 2 for building source stimuli movement behavior with user-specified parameters.

FIG. 11 is an exemplary screen generated from the computer of FIG. 2 depicting resultant sound exposure levels.

FIG. 12 is an exemplary screen generated from the computer of FIG. 2 for inputting user-specified run time and time resolution parameters.

FIG. 13 is an exemplary screen generated from the computer of FIG. 2 depicting tracked whale detections and signal excesses.

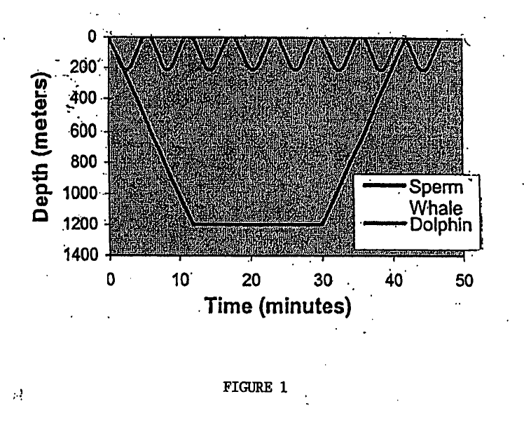

### DETAILED DESCRIPTION OF PREFERRED EMBODIMENTS

The present invention overcomes many of the prior art problems associated with evaluating the introduction of stimulus into marine environments. The advantages, and other features of the methods and systems disclosed herein, will become more readily apparent to those having ordinary skill in the art from the following detailed description of certain preferred embodiments taken in conjunction with the drawings which set forth representative embodiments of the present invention.

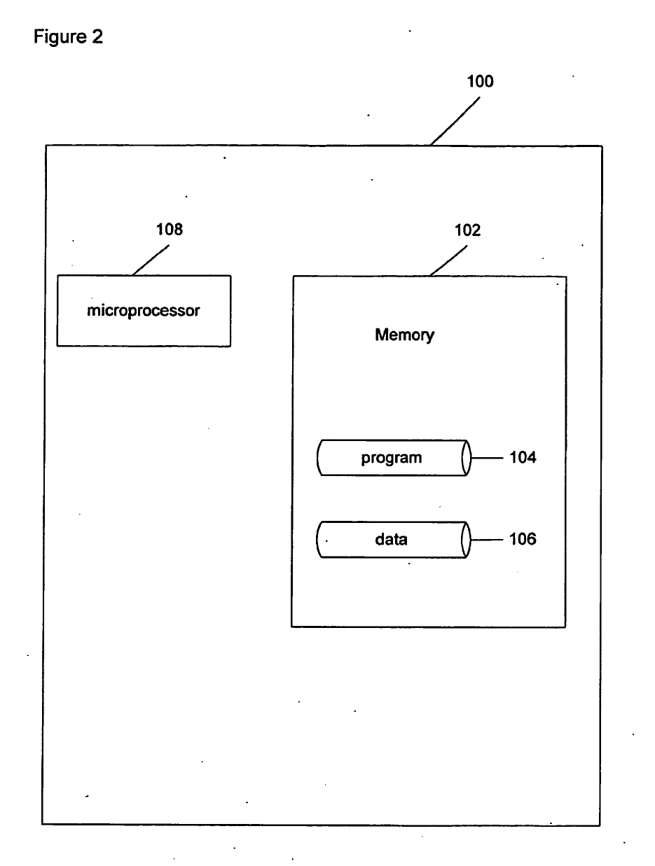

Referring now to the FIG. 2, there is shown a somewhat schematic diagram of a computer 100 with memory 102 having a program 104 and data 106 so that a processor 108 can implement the method of the present disclosure. The preferred method combines a behavioral animat movement and tracking model in combination with a source stimulus propagation model to quantify expected levels of stimulus dosages in a virtual environment, as well as the potential for detecting an animal by active means. When the passive detection of the animal as the animal vocalizes is the object, the animal is modeled as a moving source and the sonar receiver is modeled as the stimuli receiver. In each emulation all of these mechanisms (animals, sources, and receivers) are preferably created from the same generic animat builder. The method of the subject disclosure compensates for the inherent variability and uncertainty of input data related to behavior animats and stimulus propagation. Preferably, the compensation is accomplished by selecting a random value from the input variable distribution and running the model as if it were deterministic. Repitition of running with random values yields a significant distribution that allows for application of statistical measures to account for the inherent variability and uncertainty.

Still referring to FIG. 2, the computer 100 may be a stand-alone desktop personal computer, a personal computer connected to a network or any of a number of servers known to those skilled in the art. If the computer 100 is a server, the server may be operably connected to a network (not shown) so as to operably link to a plurality of clients (not shown). As illustration, the server would typically include a central processing unit including one or more microprocessors such as those manufactured by Intel or AMD, random access memory (RAM), mechanisms and structures for performing I/O operations, a storage medium such as a magnetic hard disk drive(s), and an operating system for execution on the central processing unit. The hard disk drive of the server may be used for storing data, client applications and the like utilized by client applications. The hard disk drive(s) of the server also are typically provided for purposes of booting and storing the operating system, other applications or systems that are to be executed on the server, paging and swapping between the hard disk and the RAM.

It is also envisioned that the computer 100 can be multiple servers in cooperation to facilitate greater performance and stability of the subject invention by distributing memory and processing as is well known. U.S. Pat. No. 5,953,012 to Venghte et al. describes a method and system for connecting to, browsing and accessing computer network resources and is herein incorporated by reference in its entirety. The computer 100 houses multiple databases necessary for the proper operation of the method in accordance with the subject invention. The computer 100 can also utilize a removable computer readable medium such as a CD or DVD type of media that is inserted therein for reading and/or writing to the removable computer readable media.

The computer 100 has a display and an input device(s) as would be appreciated by those of ordinary skill in the pertinent art. The display may be any of a number of devices for displaying images responsive to outputs signals from the computer 100. Such devices include but are not limited to cathode ray tubes (CRT), liquid crystal displays (LCDS), plasma screens, printers and the like. It should be recognized that the signals being outputted from the computer 100 can originate from any of a number of devices including PCI or AGP video boards or cards mounted within the computer 100 that are operably coupled to the microprocessor 108 and the display. In illustrative embodiments, the input devices may be a modem, a small systems computer interface, an ethernet link, a switch, a slide, a mouse, a track ball, a glide point or a joystick, a microphone or other such device (e.g., a keyboard having an integrally mounted glide point or mouse) by which a user can input control signals and other commands. Although the use of a keyboard as an input device is not described further herein, it is within the scope of the present invention for the input device to comprise any of a number of keyboards known to those skilled in the art, wherein the control signals or commands for implementing and interacting with the computer 100 and the applications program embodying the disclosed methodology can be implemented in the form of discrete commands via a keyboard.

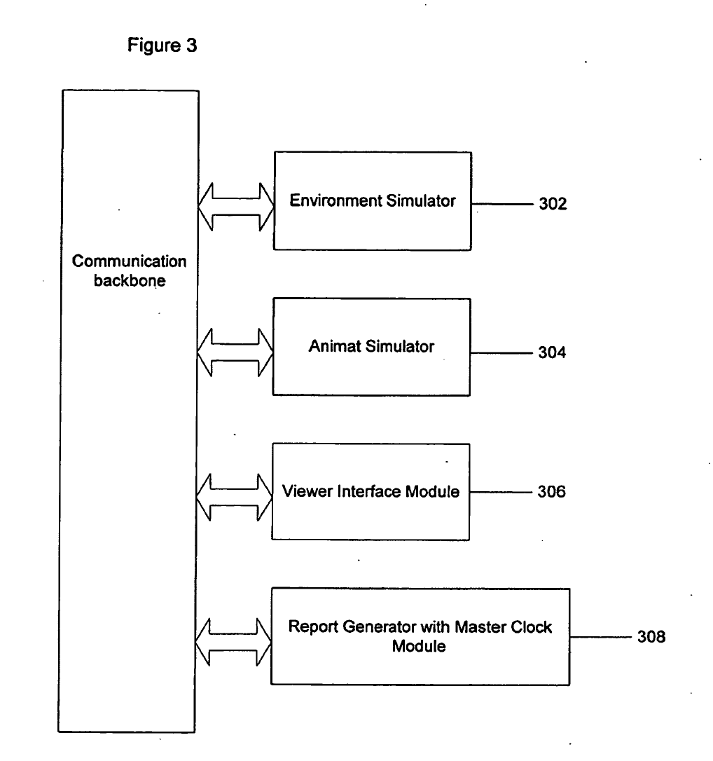

Referring to FIG. 3, a somewhat schematic view of the functional modules of the program 104 for accomplishing the disclosed method is shown. The various modules may all be accomplished with a single computer, a plurality of computers linked by a communication backbone 310 as shown and combinations thereof. Preferably in a single computer application, the data 106 and program 104 are accessed by small pieces of interface or “glue” code. This approach allows for additional models or databases to be interfaced with minimal additional coding. For aquatic applications, the computer 100 supports the Bellhop and PE (NSPE) v5.0 models, the DBDB-V4.2, ETOPO5 and the ETOPO 2 bathymetry databases and GDEM 2.6 sound velocity profile database. Each module or engine and all supporting databases are kept as separate programs and files. In a preferred embodiment, the necessary data for a run of the method are be stored in a project file. By accessing a project file, a user can easily modify existing projects and rapidly implement subsequent runs with one or more modified values. In one embodiment, the program 104 is a desktop computer application that is either downloaded or provided on a compact disk. In another embodiment, the program 104 is offered as an Internet hosted application.

The program 104 includes an environment simulator 302 for modeling an actual environment within the computer 100, e.g., creating a virtual environment. The environment simulator 302 includes parameters related to the environment such as, without limitation, location, terrain, time of year, stimulus propagation properties, salinity and the like. The environment simulator 302 determines conditions as well as which species are present, in what numbers, and their behavioral state. Typically, these factors vary seasonally and spatially.

In an alternative embodiment, the program 104 employs existing models and databases to simulate the virtual environment. By accessing environment specific models and databases, the environmental simulator 302 can be written as a generic utility with broad applicability. Similarly, other modules and simulators may be written generally and access application specific plug-ins. Moreover, storing project files allows for “what-if” analysis of a plurality of scenarios.

The program 104 also includes an animat simulator 304 that is the artificial intelligence for moving the creature animats within the virtual environment. The animat simulator 304 simulates the creatures and includes a library of basic controls for modeling the creature movements. The animat simulator 304 ensures that the creatures move, fall, float and bounce according to natural laws. The animat simulator 304 not only models creatures but the stimuli as well. Thus, sources and receivers are referred to as animats herein.

The animat simulator 304 also distributes the creatures at the start of simulation and maintains tracking toward destinations. The initial distribution of animats can be randomly generated or input by a user based upon historical surveys and the like. For birds, tracking toward a destination may mean that migratory birds track along migratory directions. Another component of the animat simulator 304 is aversion and attraction control. As a result, rules can be implemented requirring animats to avert from certain regions of the environment (e.g., whales avoiding certain sounds) or steer towards desirable areas (e.g., whales seeking krill that were attracted to areas rich in phytoplankton). Both the level of stimuli and the level of aversion can be controlled by the user based either on an empirically derived rule, or in a parametric way to examine the total range of responses.

In a preferred embodiment, the computer 100 accesses and employs existing models and databases such as the Global Information System.

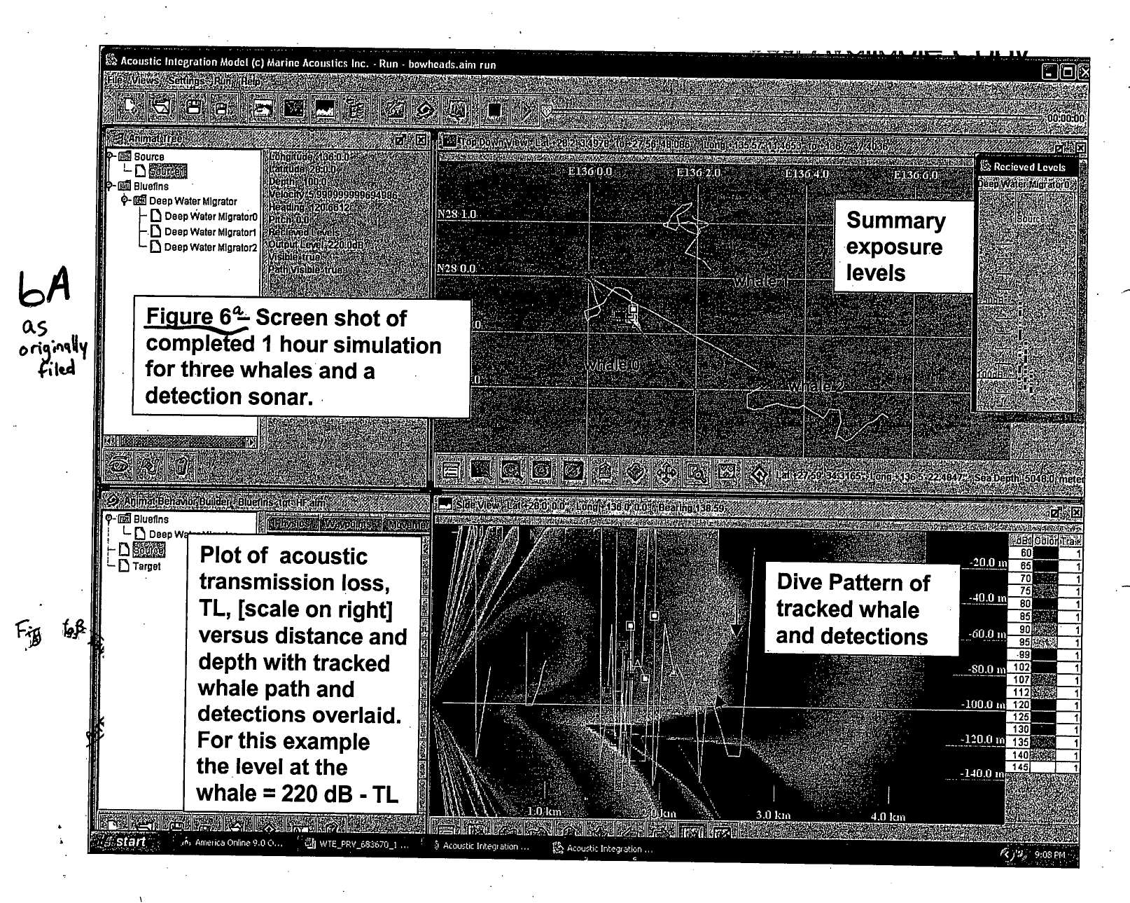

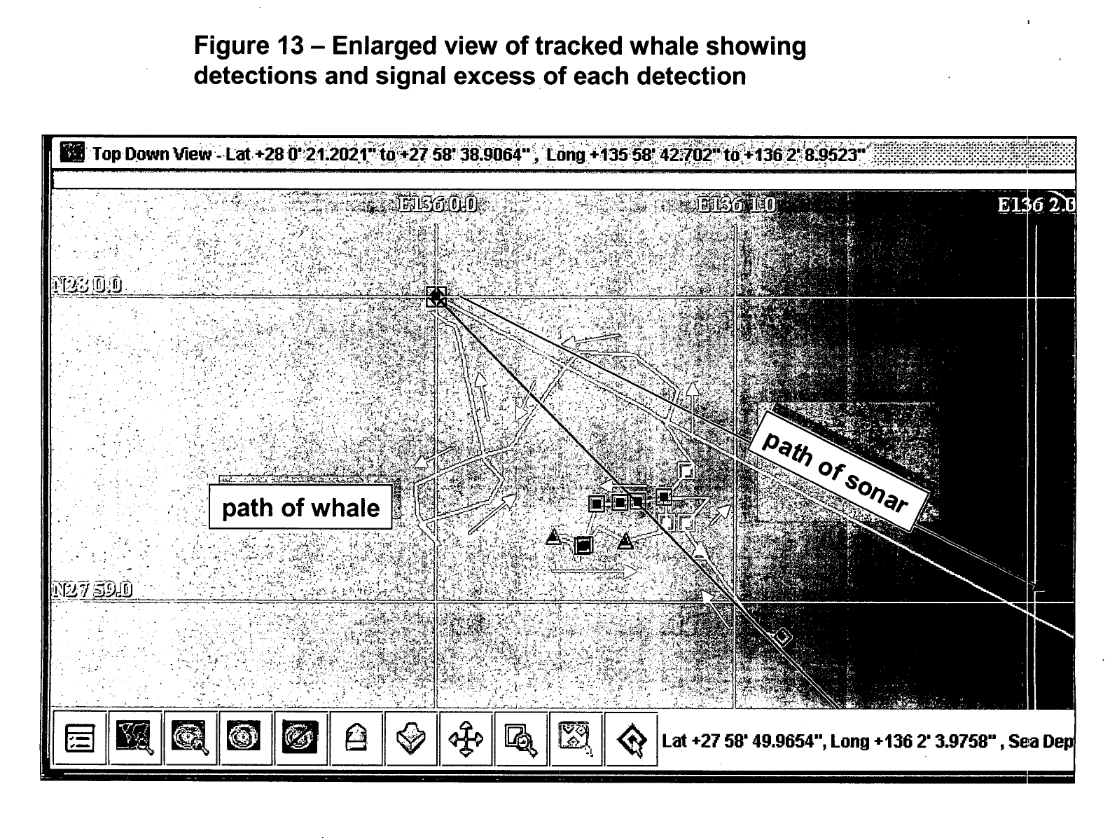

Still referring to FIG. 3, the program 104 also includes a viewer interface module 306 for presenting graphical displays of the environmental and animat data. The displays can be two or three dimensional views of the geopgraphical world, charts, graphs and the like. Preferably, the user can select a desired output. For example, the user may review horizontal or vertical cross-sectional views of the virtual environment as shown in FIGS. 6A and 6B, respectively, or a camera view or focus on a single animat to examine its path and dosage at each interval. Exemplary displays are further disccused below with respect to FIGS. 6 through 13.

A report generator with master clock module 308 of the program 104 synchronizes each component 302, 304, 306 so that the locations and movements of the animats are coordinated. Thus, when a sound or other stimuli is present in the virtual environment, the response can be determined based upon the location of the animats. Thus, at any instant the location of all animats is known in 3-D space along with any propagated field stimulus values at the same locations. Preferably, the interval steps, from the start of the emulation to the end time, are set for time resolutions inversely proportional to a sampling rate at least twice that of the rate at which the animats might change their behavior. For example, if a whale could change depth every 2 minutes, then an interval of 1 minute or less would be appropriate, with the preferred interval being set by the animat variable with the highest rate of change. FIG. 12 shows an exemplary screen in which the preferred intervals and run time may be entered.

For each interval, the report generator with master clock 308 calls each component 302, 304, 306 Additionally, the report generator with master clock 308 collects the generated data and calculates the statistical significance thereof based upon cross-correlation of the data. For example, the report generator with master clock 308 creates a report for each animat that includes the dosage and location for the given animat at each interval. The report generator with master clock 308 also can preferably replay the simulation showing the movement and interaction of each animat in the virtual environment.

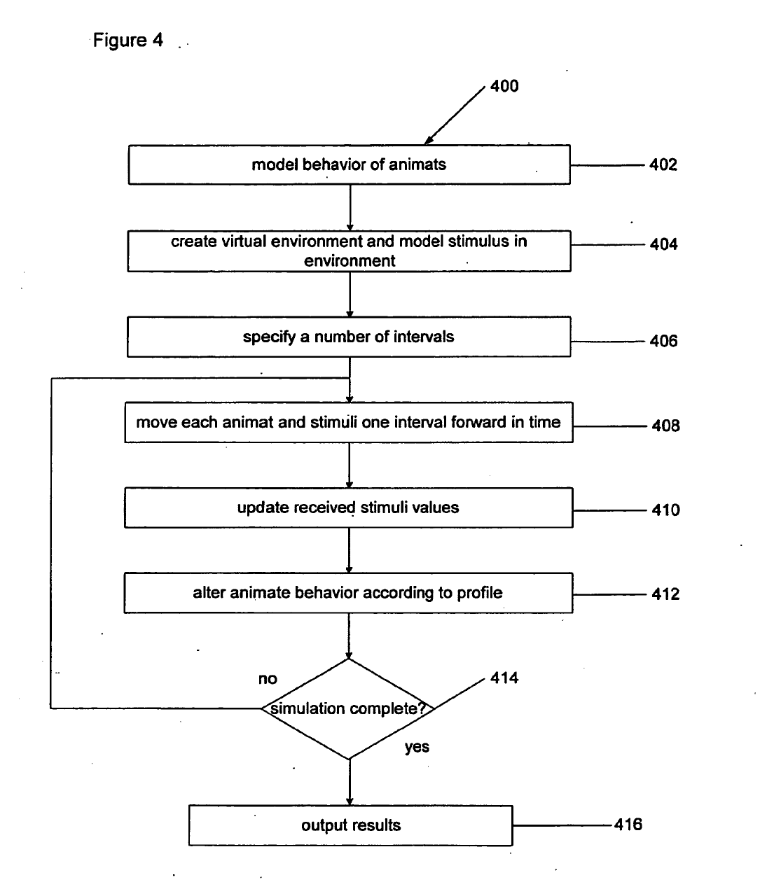

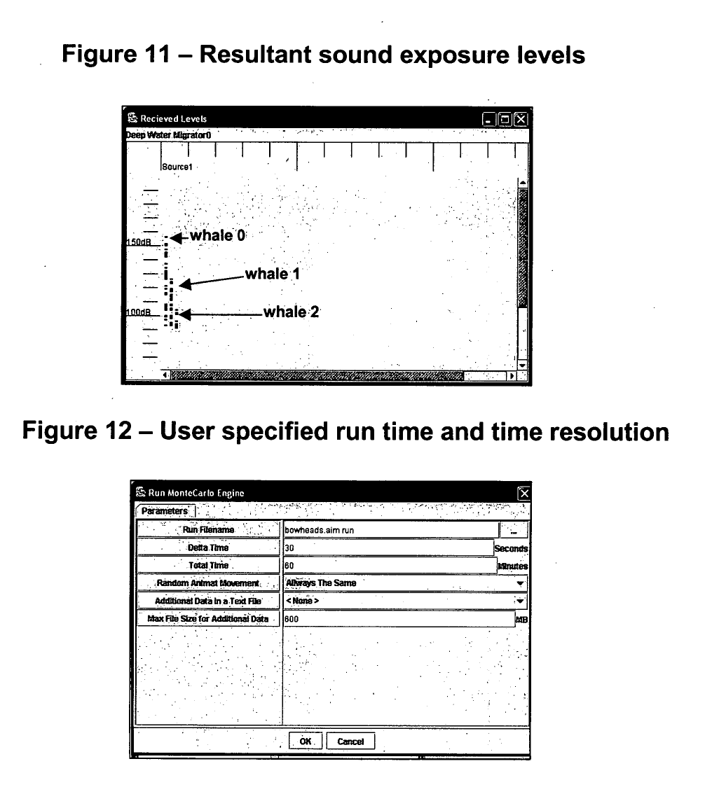

Referring now to FIG. 4, there is illustrated a flowchart depicting a method 400 for generating dosages for marine mammal animats in a virtual environment in accordance with an embodiment of the present invention. In the preferred embodiment, a company or other entity (not shown) provides a computer 100 to utilize the subject method 400. As best shown in FIG. 11, the user can review the dosage information in a plurality of formats, that being one preferred format illustrated.

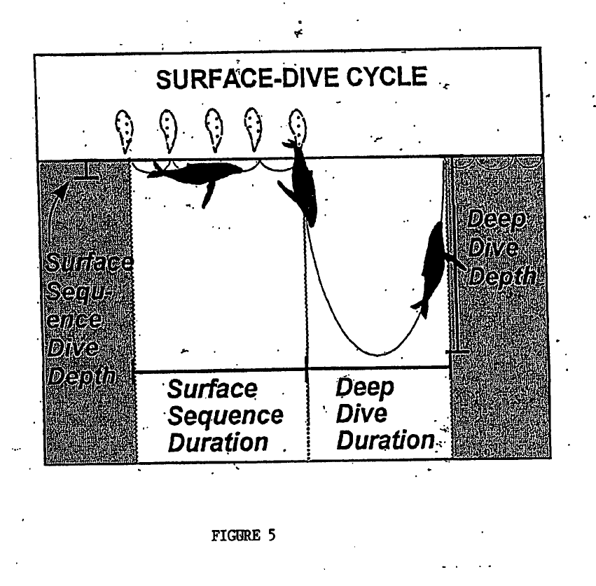

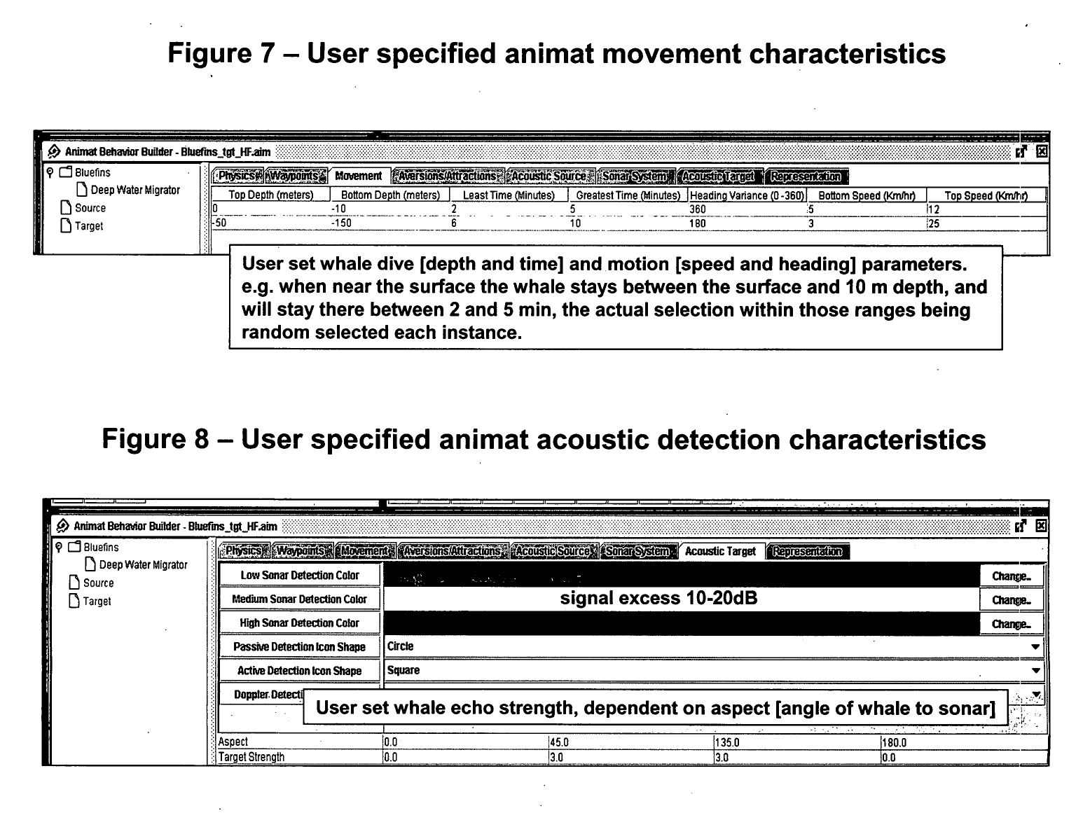

At step 402, the animat simulator 304 models the behavior of the one or more animat individuals of interest. For example, based upon empirically generated data, a profile to predict the movement and behavioral patterns of whales in response to a set of parameters is generated and stored. The profile can include rules, characteristics and responses that govern the whale response in different contexts. For marine mammals, accurately modeling the dive pattern increases the accuracy of the simulation. Preferably, the duration, depth, speed and direction characteristics of each dive type are input separately according to Table 1 and as shown in FIGS. 6 and 10. By creating as many dive types as necessary, complex movement patterns can be created such as the exemplary cetacean surface-dive cycle illustrated in FIG. 5. The goal is not to perfectly recreate actual individual paths, but to create a population of animats that statistically capture the “typical” movements of a population of individuals. Where the whale simulation is to demonstrate active tracking by sonar, the user also inputs the echo generating characteristics of the whale as shown in FIG. 8.

TABLE 1

Movement Parameters
Dive Time (min/max)
Dive Depth (min/max)
Speed (min/max)
Initial Course
Variance in Course

It is noted that the dosage-response curve or relationship is difficult to establish. However, there is currently a large body of work in progress on responses of marine mammals to noise. Based on this work to date, it appears that certain levels produce behavioral responses as well as physiological responses, such as temporary threshold shift (TTS). Empirical data can be used to bound the levels of exposure necessary for behavioral reactions and physiological response. For example, most marine mammal researchers would agree that behavioral responses begin well before the onset of TTS, which probably begins around 180 dB for mysticetes and 190 dB for dolphins Alternatievely, values for response parameters can be evaluated and conservative placeholder values used. A great advantage of this simulation model is its ability to rapidly predict the statistical change in numbers of impacted animals as the dosage thresholds are varied, i.e. a regional population sensitivity index can be created. At step 404, the environment simulator 302 creates the virtual environment and models the stimulus in the virtual environment. As best shown in FIG. 6-12, screens for entering parameters are preferably as intuitive as possible. The simulation creates the most accurate virtual environment when the environmental data is detailed and accurate. In a preferred embodiment, environmental data are based on current, in-situ measurements of the highest resolution. In the absence of real-time in-situ measurements for the site of interest, e.g. for planning a future operation, the requisite data can be automatically extracted from a variety of seasonal data bases for virtually any required input. For example, the ETOPO series (version 2 and 5) bathymetry database and the GDEM 2.6 sound velocity database can provide relatively accurate input for bottom parameters and acoustic sound velocity profile for any seasonal date and site in the world.

The environment simulator 302 uses the input parameters location and time of year as a key for the user to to categorize and delineate the species that are present as well as their behavioral state, distribution and abundance. Alternatively, a database that possesses all of this information can be accessed. In still another embodiment, certain databases that include a subset of the desired data can be accessed and utilized by the computer 100. For example, regional databases produced and updated by the National Marine Fisheries Service can provide rough abundance estimates. Other sources of data available to the user include research papers, reports and unpublished data. In a further example, within the method of the subject disclosure, density is also structured. For example, the nearshore density of dolphin may be much higher than the offshore density. Once the number and identity of animals has been determined, it may be necessary to program in behavioral characteristics for animals in which profiles were not created in step 402.

As noted above, each source and/or receiver is modeled as an animat. As stated, sound generation sources can be either animals, sonar systems, ship noise, or other forms of naturally occuring and manmade noises. Similarly, receivers can also be either sonar systems or animals. Each are preferably generated by the animat simulator 304. The broad generality of the animat simulator 304 also allows use for virtually any physical sensory source including chemical, olafactory, electro-magnetic, acoustic and others. For acoustic stimuli, the source characteristics of frequency, source level, duration and interval between sound generation are preferably specified. What is needed to implement the other source types is source spectral strength, source directivity, and operating function over time. The propagation of the stimuli through the environment is also modeled using the model most appropriate to the source type.

Each creature animat has parameters that control its speed and direction in three dimensions. Thus, it is possible to recreate the type of diving pattern that an animal shows in the real world. Furthermore, the profile governs the movement of the animats so that the animat responds to environmental factors, such as water depth and sound level. In this way, species that normally live in specific habitats can be constrained in the virtual environment to stay within that habitat.

At step 406, once the behavior of the animats has been generated and the virtual environment created, a user initiates a simulation run. To determine the length of the virtual simulation, the user inputs a number of steps forward or intervals in time (see FIG. 12) and the method 400 proceeds to step 408.

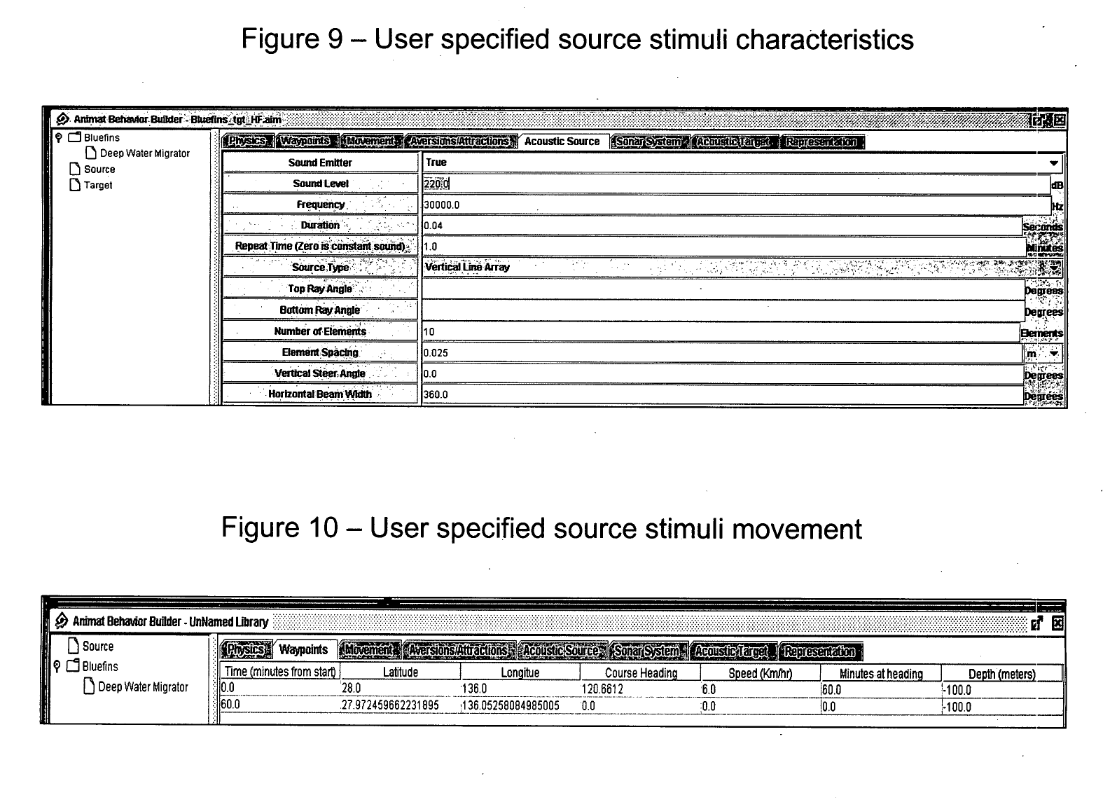

At step 408, for each time interval, each animat is moved within the virtual environment according to the associated profile. The animat simulator 304 ensures that each animat's behavior is governed by species specific rules such as speed, depth, dive pattern, breathing rate and the like. For example, whales that are singing continue to sing, birds in flight continue flapping their wings and humans that are walking continue to move their legs. The stimulus animats are simlarly animated through the time interval. In all of these simulations any or all of the animats can also be completely controlled deterministically. For example, whales may be programmed, as described above, to follow general dive and movement rules with a statistical variation being applied at the requisite sampling intervals, whereas a shipborne sonar may be programmed to move at specific courses and speeds through the adjoining environment (see FIGS. 9 and 10) This latter feature allows for highly accurate exercise planning as well as post-evaluation of an actual exercise event.

At step 410, the received stimuli values or dosage are updated for each time interval. For example, in the case of acoustic stimuli such as submarine sonar, the dosage update is done in two steps. First, the submarine sonar animat is propagated through the virtual environment based upon its frequency, directivity, duration, and source level (see FIG. 9). As a result, by knowing the location of each creature animat at the same virtual time, the exposure to the stimulus animat can be determined and stored for that interval. A total dosage can ultimately be determined by assessing the dose for each interval.

Referring to FIGS. 6A and 6B as exemplary, steps are summarized that demonstrate where three whales have been simulated for one hour along the track of a traversing sonar system capable of detecting these whales. As shown, only one whale, number 0, is detected as the other two are always at too great a range. The detections of whale 0 are preferably shown by color or gray scale related to the echo strength received at the sonar. The sonar is operating at a depth of 100 m with a ping every minute (see FIGS. 7 and 9). The resultant path of all four animats (source and three whales) are shown, the whales in a meandering path following their programmed parameters (see FIG. 7), and the sonar in a straight course (see FIG. 10). FIG. 11 displays the calculated received acoustic levels at each of the three whales over the one hour period.

At step 412, at the end of each interval, each animat reevaluates the environmental variables (both aversions and attractions) to which the profile determines the animat should respond. If a variable has exceeded the set limit, the animat will alter its behavior accordingly. For example, an animat of a whale changes from its migrating path if the animat encounters sound above a given level or water that is too shallow. The whale animat may turn away at a user-specified angle and maintain the new direction until the sound level drops to a user-specified lower value. Similarly, human animats can be modeled to move away from adverse odors in a virtual environment. At step 414, computer 100 determines if all the intervals have been executed. If so, the computer 100 proceeds to step 418 to generate the user-selected results (see FIGS. 5 and 6). If not, the method 400 continues to iterate until all of the intervals have been evaluated. The iteration allows for the alteration of behavior in response to a changing environment. As a result, the creature animat behavior can be accurately reproduced.

At step 416, the output of the method 400 is ready for review by the user. In one embodiment, the output is a text file record of all the variables in the model for each time step for each animat. The exposure history of each individual animat can be displayed as a table, graph and the like. The text file can also be exported to an ASCII file for subsequent detailed analysis. Because the real exact positions of both stimulus (i.e., sources) and animats (i.e., receivers) are usually not known, multiple runs of realistic predictions are preferably used to provide statistical validity. In this instance, the text files for each simulation are statistically combined in a manner appropriate to the modelling being sought. As a result, the method 400 is capable of very accurate predictions of exposure to a stimuli or dosage. Dosage represents a significant step in assessing the effect of stimuli.

### EXEMPLARY APPLICATIONS OF THE METHOD

A. Take Estimation/Pre-Mission Planning

It is envisioned that the method 400 can be used to estimate the effect of any sound producing system. The system's geographic operating range and schedule of operations are established and input. In order to estimate the exposure of animals to the operation of the sound producing system, numerous sites within the geographic range are selected and modeled. If the scope of operations occurs over different seasons, the individual conditions for each season as well as changes in the behavior and distribution of the animals present are entered. In a preferred embodiment, the net sound exposure on individual animals or ‘dosimeter’ readings are the output. The history of sound exposure for each virtual animal is tabulated and available for review. The receiving animats are programmed to respond to a variety of stimuli including the received sound level. The choice of variations and the degree of response are programmable by the user, allowing a parametric evaluation. Examples where this approach applies include Navy sonar operations, geophysical seismic operations and acoustical research in the ocean.

Of course, the method 400 can consider additional sources of stimuli, operated in different areas and in varying fashions. Essentially, the method 400 can be used as a ‘what-if’ tool, to predict the potential impact and compare the impacts of different operational scenarios. Various simulations can alter the timing and/or location of tests or operations, the sources used and the parameters of those sources. Further, different times of year can be evaluated. At a finer scale, different operational procedures or duty cycles can be evaluated and predicted. Thus, the method 400 allows for a systematic and efficient evaluation of the potential for minimizing the impact of an operation by optimizing parameters before deploying.

B. Behavioral Modeling

The subject method 400 can also be used to develop behavioral reaction models for real-world events where both the stimuli and animal responses are known. The events can be simulated in the computer 100 with the goal of developing aversion rules that most accurately reproduce the actual event. For example, there was a recent stranding of a whale as the result of the passage of noise-producing vessels. The acoustic characteristics of the vessels are known, as are the numbers and locations of the stranding events. It is well within the capability of one of skilled in the art, and based upon review of the subject disclosure, to program the computer 100 to reproduce the movements and acoustic transmissions of the vessels and a distribution of receiver animats representing whales. A series of different aversion rules can be developed based on known responses of other species to acoustic stimuli.

For example, with respect to whales, a plurality of rules can be formulated and utilized to determine which rule or combination of rules yield results that most closely approximate actual outcomes. For the stranding event, three aversion rules of strong avoidance of sound at 180, 150 and 120 dB received levels were created. Whales could also exhibit a scaled response, with strong avoidance at 180 dB, moderate avoidance at 150 dB and weak avoidance at 120 dB. It was further postulated that whales have no aversion to sound. The method 400 was run multiple times with each of the behavioral rules. The results indicated that the scaled response to sound level produced the result that most closely matched the actual event. This finding suggests that the response of the whales may scale with received level. Additional values, such as persistence of response, thresholds for return to baseline behavior and the like can also be tested.

C. Acoustic Censusing

A vital measurement when conducting censuses is determining the effort, or area covered by the census. For visual censuses of marine mammals at sea, the area covered is typically the product of a ship track length multiplied by the visual swath width. However, acoustic censuses are less straightforward. If one knows, or has reasonable information on the diving behavior of the species present, then the effective acoustic search area could be determined by convolving the vertical distribution of the each species with the site-specific and seasonal propagation pattern to determine how much of the ocean is being ‘listened to’. The great unknown in acoustic censuses is the proportion of animals that are vocalizing. It is possible that with an increasing number of acoustic and visual surveys, the comparison of acoustic and visual detection rates, corrected for propagation, will allow this value to be bounded, if not determined.

D. Avoiding Ship Strike

Ship strikes are a long-standing threat to marine mammals. For healthy populations, it is an unfortunate event. However, for populations that are critically reduced in numbers, such as the northern right whale, a single death represents a significant decrease in the population viability. Recent tagging efforts have revealed more information about the habitat usage patterns of some marine mammals. If relocating shipping lanes can be used to reduce the ship strike threats, the feasibility and effectiveness of these changes could be evaluated by using the subject method 400.

E. Ship Noise Exposure

A difficult parameter to quantify is the long-term effect of any stimulus on the viability of a population. T It would be feasible to recreate the shipping routes and whale migratory routes within an ocean basin. Historical databases describe the levels of vessel traffic. The method 400 could be utilized to track the noise exposure of an individual throughout an entire lifespan. Present day conditions could be compared with historical data. This approach would also allow the evaluation of the potential of noise, such as that from shipping, to mask biological sounds that may be important to the survival of a given species.

F. Air Gun Surveys

The issue of seismic exploration is becoming an increasingly important as the role of airguns expands and the need for data collection continues. Currently airgun operations are required to use very strong mitigation measures, up to and including prevention of nighttime operations and very large safety ranges. Any marine mammal or turtle in this range requires the airgun vessel to stop firing. These are expensive efforts. The method 400 could be used to model airgun operations and model the sound exposures. The parametric evaluation of different operational methods could be used to reduce exposures and, thereby, reduce expense and difficulty.

G. Naval Test Plans

The capability of the method 400 to model the effectiveness of sonar operations against underwater vehicles is straightforward and fully comparable and consistent with much of the methodology used to conduct acoutsic impact asessments. The method 400 is particularyly apt for two phases of naval operations, the planning phase and the post operation reconstruction phase. In the former case, the ability to perform the ‘what-if’ parametric evaluation of key parameters, e.g. submarine course, speed and depth, in a direct and user-controlled way represents a significant ability over current methods. In the latter case, actual performance can be directly reviewed against predicted performance. The application of these methods to other sensor types such as radar are straightforward and directly adaptable to method 400.

H. Acoustic Reverberation and Clutter Modeling

A key component of acoustic modeling in the ocean is the unwanted backscattered echos from both biological and geophysic sources. The method 400 allows for a first cut assessment of the discrete components of this process, termed ‘clutter’. This is the form of reverberation that most resembles an actual target and is one of the highest priority issues of sonar research. The ability to model biological clutter from marine mammals and fish schools using the method 400 is straightforward and of extreme value to the needs of the sonar research community. By combining this capability with the naval test planning just described one knowledgeable in this field can make reasonable assessments of the effect of the clutter on the general effectiveness of sonar operations in that area.

I. Pollution

The broad spectrum of pollution in the world's oceans is a growing concern to all nations. The capability of the method 400 to simulate the exposure level of animals residing in the path of pollution provides a powerful tool to estimate the first order of exposure resulting from such an event. For example, the computer 100 can model the migration of an oil spill plume over time using any of a number of oil plume migration models currently available.

J. Masking

Masking is one of the issues frequently raised when considering the effects of sound in the ocean. Masking is essentially a reduction in signal excess as the level of masking noise rises. The reduced signal excess can limit the effective range of the animal's own signals as well as the range over which the animal can hear. As most animats (both man-made and animal) can both produce and receive (hear) sounds, it is a straightforward adaptation of the method 400 to determine the ability of a given animat to hear a sound produced at a distance by another animat in terms of such parameters as signal level, duration, frequency and background noise.

K. Sonic Boom Impact

The method 400 can be adapted to interface with a sonic boom model to allow for the assessment of sonic boom over-flights on the marine habitat.

L. Pest Control

With the advent of advanced pest control devices such as mosquito vacuums that attract mosquitos by CO₂ and other scents, a need exists to optimize the efficiency of such devices. It is envisioned that an area can be modeled and various placements of the devices can be evaluated to determine optimum placement and duty cycle.

Preferably, all forms of stimuli can be modeled as a source that propagates where a level of the stimulant at a location and time can be created. Not only can the method 400 model the dosage of animats but typical reactions can further refine the accuracy of the simulation.

### DATABASE AND MODEL REFERENCES

The following is a referential description of certain databases and models that may be advantageously used in conjunction with the subject disclosure as would be appreciated by those of ordinary skill in the pertinent art:

The ETOPO5 data may be credited in publications by reference to:

“Data Announcement 88-MGG-02, Digital relief of the Surface of the Earth. NOAA, National Geophysical Data Center, Boulder, Colo., 1988.”;
   ETOPO2
ETOPO2 Global 2′ Elevation. 2001. National Geophysical Data Center, Boulder, Colo.;
   DBDB-V 4.2
Database Description for the Digital Bathymetric Data Base—Variable Resolution (DBDB-V) Version 4.2. 2002. Naval Oceanographic Office, System Definition Branch, N641;
   GDEM 2.6
Data Base Description for the Generalized Digital Environmental Model—Variable Resolution (GDEM-V) OAML-DBD-72D. Naval Oceanographic Office 2002;
   Bellhop
Porter, M. B. 1992. The KRAKEN normal mode program. NRL/MLR/5120-92-6920.99 pages
   A theoretical description may be found in:
Michael B. Porter and Homer P. Bucker, “Gaussian beam tracing for computing ocean acoustic fields,” J. Acoust. Soc. Amer. 82, 1349-1359 (1987).
   Software available from:
http://oalib.saic.com/Modes/AcousticsToolbox; and
   Navy Standard PE (NSPE) v5.0
Software Requirements Specification for the Parabolic Equation/Finite Element Parabolic Equation Model Version 5.0. OAML STD-22. 1999.
Software Design Document for the Parabolic Equation/Finite Element Parabolic Equation Model Version 5.0. OAML SDD-32. 1999.
Software Test Description for the Parabolic Equation/Finite Element Parabolic Equation Model Version 5.0. OAML STD-22. 1999.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, engines, interfaces, computers, servers and the like) shown as distinct for purposes of illustration may be incorporated within other functional elements in a particular implementation.

While the invention has been described with respect to preferred embodiments, those skilled in the art will readily appreciate that various changes and/or modifications can be made to the invention without departing from the spirit or scope of the invention as defined by the appended claims.

1. A computer for modeling an impact of a stimulus upon an environment, wherein the computer comprises:
(a) a memory storing an instruction set and data related to a plurality of time intervals, an environment, at least one creature animat and the stimulus; and
(b) a processor for running the instruction set, the processor being in communication with the memory, wherein the processor is operative to:
(i) initially distribute the at one creature animat in a virtual environment based upon the data related to the environment;
(ii) simulate a behavior of the at least one creature animat and a propagation of the stimulus for each time interval; and
(iii) record a dosage of the stimulus upon the at least one creature animat.

2. A computer as recited in claim 1, wherein each time interval is inversely proportional to a sampling rate at least twice that of a rate at which the at least one creature may change behavior.

3. A computer-readable medium whose contents cause a computer system to perform a method for predicting exposure to stimulus, the computer system having a program and at least one database with functions for invocation by performing the steps of:
creating an animat simulator having access to data related to the stimulus and a receiver of the stimulus;
creating an environmental simulator having access to data related to a virtual environment that represents an actual environment; and
simultaneously running the animat and environmental simulators to predict exposure to the stimulus over a plurality of intervals.

4. A computer-readable medium as recited in claim 3, wherein the receiver is a discrete object that obeys a set of rules to determine movement patterns.

5. A computer-readable medium as recited in claim 4, wherein the discrete object is selected from the group consisting of a bird, a marine mammal, a car, an elephant, a human, a mosquito and a fish.

6. A computer-readable medium as recited in claim 3, wherein the stimulus is selected from the group consisting of repititious sound, dynamic sound, non-stationary sound, an oil spill, factory pollution, and nuclear fallout.

7. A computer-readable medium as recited in claim 3, wherein the stimulus is any field that can be expressed in terms of a geopgraphically field statically over time.

8. A computer-readable medium as recited in claim 3, wherein the data related to a virtual environment includes sets of latitude, longitude and height.

9. A computer-readable medium as recited in claim 8, wherein the data related to a virtual environment includes terrain locations.

10. A computer-readable medium as recited in claim 3, wherein the data related to a virtual environment includes bathymetry, temperature, wind, salinity and sound.

11. A system for simulating an environment having creatures and at least one stimulus source, the system comprising:
a first means for modeling the environment;
a second means for modeling the creatures and the at least one stimulus;
a third means for presenting data generated by the first and second means to a user;
a fourth means for synchronizing the first and second means.

12. A system as recited in claim 11, wherein the first means is an environment simulator, the second means is an animat simulator, the fourth means is a viewer interface module and the fifth means is a report generator with master clock module.

13. A system as recited in claim 11, wherein the fourth means causes the first and second means to iterate through a plurality of time steps.

14. A system as recited in claim 13, wherein multiple simulations are utilized to statistically evaluate the data generated by the first and second means, each of the multiple simulations having a project file characterizing the environment.

15. A system for simulating an environment having creature animats comprising:
a first means for modeling the environment;
a second means for modeling the creature animats;
a third means of determining the transmitted field of the sensor system;
a fourth means of modeling the reflection or scattering strength of the creature animat;
a fifth means of determining the level of the scattered energy at a receiver sensor;
a sixth means of evaluating the net effectiveness of the detection based on environemtal variables such as noise; and
a seventh means for presenting data generated by the first through sixth means to a user.

16. A system as recited in claim 17, wherein the first means is an environment simulator, the second means is an animat simulator, the third means is a sensor system, the fourth means is a computer simulator, the fifth means is a sensor system, the sixth means is a viewer interface module and the seventh means is a viewer interface module.

17. A system for simulating an environment having creature animats and at least one passive detection sensor system, comprising:
a first means for modeling the environment;
a second means for modeling the creature animats;
a third means of determining the transmitted field of all animat sources;
a fourth means of determining the level of the source energy at a receiver sensor;
a fifth means of evaluating the net effectiveness of the detection based on environemtal variables such as noise; and
a sixth means for presenting data generated by the first through fifth means to a user.
